(19) United States
(12) Patent Application Publication
(10) Pub. No.: US 2018/0199506 A1
(43) Pub. Date: Jul. 19, 2018

(54) SELF-PROPELLED GRASS MOWER AND SELF-PROPELLED WHEELED APPARATUS

(71) Applicant: HITACHI KOKI CO., LTD., TOKYO (JP)

(72) Inventors: Tatsuya ITO, IBARAKI (JP); Yoshio IIMURA, IBARAKI (JP)

(73) Assignee: HITACHI KOKI CO., LTD., TOKYO (JP)

(21) Appl. No.: 15/743,668

(22) PCT Filed: Aug. 26, 2016
(86) PCT No.: PCT/JP2016/075003

§ 371 Date: Jan. 11, 2018

(30) Foreign Application Priority Data
Sep. 24, 2015 (JP) 2015-187533

(51) Int. Cl. A01D 34/00; G05D 1/02; A01D 34/78; A01D 34/64; A01D 34/81

(52) U.S. Cl. CPC A01D 34/008; G05D 1/021; A01D 2101/00; A01D 34/64; A01D 34/81; A01D 34/78

(57) ABSTRACT

“A self-propelled grass mower and a self-propelled wheeled apparatus that can perform precise guidance control by reliably detecting a guidance signal with a guidewire are provided. The self-propelled grass mower includes wheel motors for driving wheels, a cutting blade motor for driving a cutting blade, a rechargeable battery for supplying electrical power to these motors, and a guidewire sensor for detecting a magnetic field generated by a guidewire formed into a loop. In the self-propelled grass mower that detects whether is inside or outside of a region enclosed by the guidewire and runs autonomously in a grass cutting region, only the supply voltage for the cutting blade motor is reduced when a magnetic field is detected by the guidewire sensor. Driving of the cutting blade motor is restarted after detection of the magnetic field has completed. Thereby, the impact of noise due to the cutting blade motor is eliminated.”

### TECHNICAL FIELD

The present invention relates to a self-propelled grass mower which has an electric motor as a driving source, autonomously travels within a grass-mowing region, and mows grass.

### BACKGROUND ART

As grass mowers for mowing lawns or weeds growing on the ground, autonomous travel-type (self-propelled-type or robot-type) grass mowers traveling automatically within a grass-mowing region defined with a wire or the like and mowing the grass have become popular. A self-propelled grass mower is provided with wheel motors that drive wheels, and a cutting blade motor that drives a cutting blade for mowing grass. In the self-propelled grass mower, a rechargeable battery which supplies power to the motors is mounted, and a control device controls autonomous travel.

When the amount of charge in the rechargeable battery drops while grass-mowing work is carried out with a self-propelled grass mower, the grass mower automatically performs return traveling toward a charging station (charging base) where a power transmission apparatus is provided, and the grass mower is then charged automatically. After the charging of the rechargeable battery is finished, the grass mower automatically restarts the work in a designated grass-mowing region. In such a grass mower, there is no need for a worker to guide the grass mower to the charging station every time charging is required, so that grass-mowing can be performed for a long period of time while the worker is absent. Here, an example of use of a self-propelled grass mower in the related art will be described using FIG. 8. A lawn (not illustrated) is spread in a yard 210 adjacent to a house 200, and is a grass-mowing region 290, that is, a target to be mowed. In the grass-mowing region 290, a self-propelled grass mower 301 is disposed on the lawn. A charging station 270 for charging the grass mower 301 is disposed in the grass-mowing region 290. The charging station 270 is installed at a corner of the lawn-mowing region and is connected to an AC adapter 250 through a cable 260. The AC adapter 250 is connected to a wall outlet (not illustrated) of a commercial AC power source or the like and converts an AC voltage (for example, 230 V) supplied from the wall outlet into a DC voltage (for example, 21 V). The charging station 270 has a DC outlet terminal (a positive electrode and a negative electrode). When the grass mower 301 arrives at a charging position in the charging station 270, the grass mower 301 stops such that its power receiving terminal (not illustrated) comes into contact with the DC outlet terminal (not illustrated) of the charging station 270. Then, power is supplied from the charging station 270 side to the grass mower 301 side, and the rechargeable battery mounted in the grass mower 301 is charged.

The grass mower 301 is provided with a plurality of wheels (for example, four), and some of the wheels are driven by wheel motors (not illustrated). In addition, a rotary cutting blade (not illustrated) which rotates on a plane substantially parallel to the ground is provided between front wheels and rear wheels when seen in a forward/rearward direction of the grass mower 301. The cutting blade is rotated by a motor (not illustrated) for a cutting blade independent from a motor for traveling.

In order to assist autonomous traveling of the grass mower 301, boundary notification means employing a boundary cable, a fence, radio communication, light, or the like is disposed in advance at a boundary part between the grass-mowing region 290 and other regions in the yard 210. In FIG. 8, a guidewire (guidance wire) 280 which is formed in a loop shape and serves as the boundary notification means is installed (for example, buried). A user of the grass mower 301 installs the guidewire 280 in advance before performing grass-mowing, and the self-propelled grass mower 301 carries out grass-mowing work within a region having the guidewire 280 as an outer edge. A guidance signal generator (not illustrated) in the charging station 270 is connected to the guidewire 280, in which a pulsed current flows at predetermined intervals. The grass mower 301 determines whether the grass mower 301 is within or out of the guidewire 280 by detecting a magnetic field generated by the current flowing in the guidewire 280, and the grass mower 301 carries out grass-mowing work while traveling automatically and autonomously.

### CITATION LIST

### Patent Literature

[Patent Literature 1]

Japanese Unexamined Patent Application, First Publication No. 2015-15922

### SUMMARY OF INVENTION

### Technical Problem

In self-propelled grass mowers in the related art as disclosed in Patent Document 1, a change in a magnetic field caused by a current (guidance signal) flowing in a guidewire is read. Accordingly, a leakage magnetic field from a stator caused due to a current flowing in a motor becomes noise in a magnetic field generated by the guidewire. Therefore, it is preferable to reduce an influence of noise from the motor. As a method of reducing the noise, (1) the scale (area) of a current loop path of a guidewire 280 may be reduced as much as possible. However, since an installation region of the guidewire 280 is determined depending on the extent of a grass-mowing region 290, it is difficult to change the installation region. As a second method of reducing noise, there is a method in which (2) a magnetic field leaking from a motor, which is a noise source, is suppressed using iron or the like having large magnetic flux capacitance. However, when iron having large magnetic flux capacitance is used as a shielding material in order to prevent leakage of a magnetic field, the shielding material requires an installation space and a main body becomes heavier. Therefore, the method is restrictive when being employed in a small-sized grass mower. As a third method of reducing noise, there is a method in which (3) a band-pass filter allowing only a particular current pulse band to pass through a guidewire sensor is inserted. Although the band-pass filter is effective, it is still difficult to completely eliminate noise.

The present invention has been made in consideration of the foregoing background and an object thereof is to provide a self-propelled grass mower which can reliably detect a guidance signal from a guidewire and can perform precise guidance control. Another object of the present invention is to provide a self-propelled grass mower which instantaneously stops energizing a motor that is a part of a plurality of motors included therein so that a guidance signal from the guidewire is read while the motor stops being energized.

### Solution to Problem

A representative aspect of the invention disclosed in this application can be described as follows. The present invention is applied to a self-propelled grass mower including wheel motors that respectively drive wheels; a cutting blade motor that drives a cutting blade; a rechargeable battery that supplies power to the motors; a guidewire sensor that detects a magnetic field generated by a current flowing in a guidewire which is formed in a loop shape; and a control device that determines, based on an output of the guidewire sensor, whether the self-propelled grass mower is within or out of a region enclosed by the guidewire, and controls autonomous traveling in a grass-mowing region. In the present invention, the control device reduces a voltage supplied to the cutting blade motor when the guidewire sensor detects a magnetic field, and restarts to drive the cutting blade motor after detection of the magnetic field is completed. That is, the cutting blade motor is in a repetitive course of energization, supply voltage reduction (inertial rotation), energization, supply voltage reduction (inertial rotation), and so on during grass-mowing work. A magnetic field is detected by means of the guidewire sensor while a supply voltage is reduced. In this manner, only the cutting blade motor performs an intermittent operation in which the supply voltage is reduced at predetermined time intervals. The wheel motors can independently perform drive control without being influenced by the driving state of the cutting blade motor.

According to another aspect of the present invention, the cutting blade is a rotary cutting blade which rotates on a plane substantially parallel to the ground. The cutting blade motor is disposed such that a rotary shaft extends in a vertical direction. The guidewire sensor has a coil for detecting a change in a magnetic field. The coil is disposed such that an axial direction is parallel to the rotary shaft of the cutting blade motor. A guidance signal generator for causing a pulsed current group to flow at predetermined time intervals is connected to the guidewire. The control device determines whether the self-propelled grass mower is within or out of the region enclosed by the guidewire, by detecting the change in the magnetic field caused by the current group a plurality of times while the cutting blade motor is stopped. In regard to this detection, when the change in a magnetic field cannot be detected within a timeout time, the control device determines that detection abnormality has occurred and stops rotation of the wheel motors and rotation of the cutting blade motor. A time for driving the cutting blade motor is set to be constant (for example, 500 milliseconds), and a time for stopping energization of the cutting blade motor is set to be variable (until a guidewire signal can be detected). The timeout time is set for a time period in which a guidewire signal is detected.

According to further another aspect of the present invention, the self-propelled grass mower includes a main body chassis that holds the wheel motors and the cutting blade motor, and a main body cover that covers the main body chassis and the motors. Front wheels are provided on a front side of the main body chassis, rear wheels are provided on a rear side, and the wheel motors are respectively provided in the rear wheels. The cutting blade motor is disposed between the front wheels and the rear wheels and the rotary shaft extends in the vertical direction when seen in a forward/rearward direction of the main body chassis. The cutting blade motor is a brushless DC motor and is provided with an inverter circuit which has a plurality of switching elements for driving the motor. The control device completely cuts off conduction of the switching elements, that is, the control device stops energization by causing a PWM duty ratio to be 0%.

### Advantageous Effects of Invention

According to the present invention, when a voltage supplied to the cutting blade motor is reduced, noise influencing the guidewire sensor is eliminated at the moment of the reduction. Therefore, the guidewire sensor can correctly read a guidance signal from the guidewire. In addition, there is no need to increase the distance between the cutting blade motor and the guidewire sensor as noise countermeasures. Therefore, the cutting blade motor and the guidewire sensor can be set close to each other compared to a configuration in the related art, so that the main body of a grass mower can be reduced in size. Moreover, since there is no need for the guidewire sensor to perform detection while the cutting blade motor is driven, a large amount of current can flow in the cutting blade motor. Thus, it is possible to carry out high-output grass-mowing work compared to grass mowers in the related art.

### BRIEF DESCRIPTION OF DRAWINGS

FIG. 1 is a perspective view of a grass mower 1 according to an Example of the present invention.

FIG. 2 is a top view of a state in which a main body cover 2 of the grass mower 1 according to the Example of the present invention is removed.

FIG. 3 is a sectional view of the A-A part in FIG. 2 seen in the rightward direction.

FIG. 4 is a block diagram illustrating various functional components installed in a main body chassis 10 of the grass mower 1 according to the Example of the present invention.

FIG. 5 is a waveform chart illustrating a current value of a current (guidance signal) which flows in a guidewire 280 and is read by a guidewire sensor 45. (1) is a waveform chart of an ideally received current, and (2) is a waveform chart read in the present Example.

FIG. 6 is a flowchart illustrating a procedure in which the guidewire reads a guidance signal in the grass mower 1 according to the Example of the present invention.

FIG. 7 is a waveform chart illustrating a current value read by the guidewire sensor 45 in a grass mower according to a Second Example of the present invention.

FIG. 8 is a view for describing an overview of an operation of a self-propelled grass mower 301 in the related art.

FIG. 9 is a view for describing a position detecting method using a guidewire sensor.

### DESCRIPTION OF EMBODIMENT

### Example 1

Hereinafter, an example of the present invention will be described based on the drawings. In the drawings described below, the same reference signs are applied to the same parts, and description is not repeated. In addition, in this specification, forward, rearward, rightward, leftward, upward, and downward directions are described along the directions in the drawings.

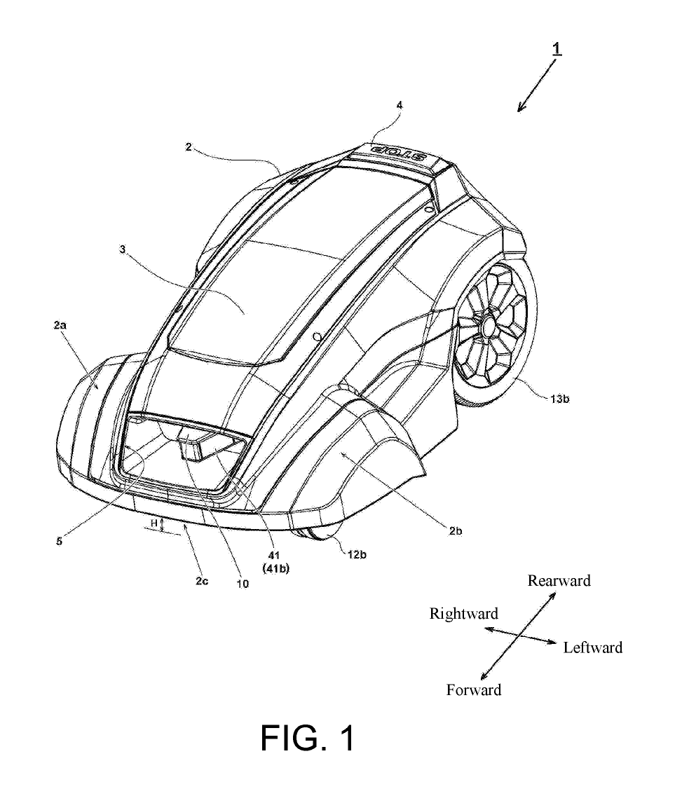

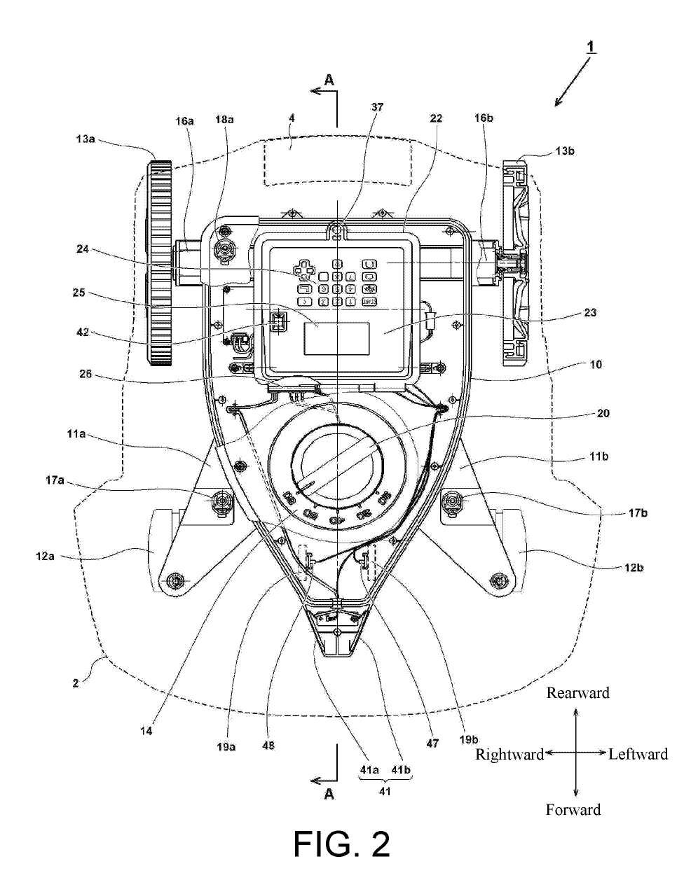

FIG. 1 is a perspective view of a self-propelled grass mower 1 according to an example of the present invention. The grass mower 1 is provided with front wheels 12a and 12b (wheel 12a is hidden in FIG. 1) which each have a small diameter and are provided to be able to make a turn or to oscillate along a traveling direction, and rear wheels 13a and 13b (wheel 13a is hidden in FIG. 1) which each have a large diameter and serve as drive wheels, respectively on the right and the left. The entire upper portion of the grass mower 1 is covered with a main body cover 2. A power source of the grass mower 1 is a battery pack (described below in FIG. 2) which is attachable and detachable. A microcomputer (hereinafter, will be referred to as a “microcomputer”) included in a control device controls driving of wheel motors (not illustrated), so that the grass mower 1 mows the grass while traveling autonomously. A front lower end 2c of the main body cover 2 is configured to have a gap of a predetermined distance H with respect to the ground, and grass which has entered the inside of the main body cover 2 through this gap is mowed by a cutting blade (described below) which is disposed on a lower side of a main body chassis 10. An opening/closing cover 3 which can be opened and closed around a turning shaft on a front side is provided on an upper side of the main body cover 2. For example, the opening/closing cover 3 is formed of a transparent resin member. When the opening/closing cover 3 is opened, a user can have access to a dial 20, a keyboard 24, and a display 25 (described below with reference to FIG. 2). An opening portion 5, which is substantially rectangular in a front view, is provided in the front of the main body cover 2, so that a power transmission terminal of a charging station 270 can come into contact with power receiving terminals 41 through the opening portion 5 at the time of charging. A tip part of the main body chassis 10 is positioned on an inner side of the opening portion 5, and the power receiving terminals 41 are respectively provided on the left side surface and the right side surface of the tip part. Fenders 2a and 2b for covering the upper portions of the front wheels 12a (refer to FIG. 2) and 12b are formed on both right and left sides of the opening portion 5 of the main body cover 2. A stop switch 4 for a manual stop is provided in the upper portion on a rear side of the main body cover 2.

FIG. 2 is a top view of a state in which the main body cover 2 of the grass mower 1 according to the example of the present invention is removed. The main body chassis 10 has the convex tip and is narrowed in a triangular shape when viewed from the top. Attachment arms 11a and 11b are respectively provided on both right and left sides such that the attachment arms 11a and 11b protrude from inclined surfaces. The front wheels 12a and 12b are pivotally supported by the attachment aims 11a and 11b and are respectively held such that the orientation of the wheels can freely follow a moving direction of the grass mower 1. The rear wheels 13a and 13b are provided on the rear side of the main body chassis 10. Here, wheels having a large diameter are used as the rear wheels 13a and 13b, which are driven by traveling wheel motors (right wheel motor 16a and left wheel motor 16b) independent from each other. The two wheel motors are driven synchronously or asynchronously, thereby allowing a microcomputer (not illustrated) mounted in a main board 26 to perform steering control. After rotary shafts of the wheel motors are decelerated by a deceleration mechanism (not illustrated) at a predetermined reduction ratio, the wheel motors rotate the rear wheels 13a and 13b. For example, when the rear wheels 13a and 13b are driven synchronously, the grass mower 1 moves forward or rearward. When the rear wheels 13a and 13b are driven such that a rotational difference is caused therebetween, the grass mower 1 can make a turn in a predetermined direction. For example, brushless DC motors are used as the wheel motors and are driven via an inverter circuit (not illustrated).

Two power receiving terminals 41 (positive electrode terminal 41a and negative electrode terminal 41b) are respectively provided on the inclined surfaces on both right and left sides in the vicinity of the tip of the main body chassis 10. Recess portions 17a and 17b, which accommodate the end portions of leaf spring portions (not illustrated) provided in an inner wall portion of the main body cover 2 such that the leaf spring portion can move within a predetermined range, are provided on the upper sides of horizontal portions of the attachment arms 11a and 11b in order to support the main body cover 2. A recess portion 18a (a recess portion near the left end portion is not illustrated), which accommodates an end portion of a leaf spring portion (not illustrated) provided in the inner wall portion of the main body cover 2 such that the leaf spring portion can move within a predetermined range, is provided near the end portion on the rear side of the main body chassis 10.

A lifting/lowering mechanism, which changes the position of the cutting blade by moving a motor (not illustrated) for the cutting blade in an upward/downward direction such that a mowing height is changed, is provided near the center of the main body chassis 10. The lifting/lowering mechanism is provided such that the dial 20 of the lifting/lowering mechanism can be rotationally operated from the upper portion. The dial 20 is rotatably held by a base portion 14 in which distances (mowing heights) of “20”, “30”, “40”, “50”, and “60” between the cutting blade (described below) and the ground are marked. When the dial 20 is set to any of the numerical values, the cutting blade (described below) and the cutting blade motor move in the upward direction or the downward direction in accordance with the set distance. A lift sensor 47 and a contact sensor 48, which detect a collision between the grass mower 1 and an obstacle, a lift state and an inclination state of the main body cover 2, and the like based on relative movement of the main body chassis 10 and the main body cover 2, are provided in front of the dial 20. Magnets 19a and 19b are provided at positions corresponding to the lift sensor 47 and the contact sensor 48, that is, on the inner wall side of the main body cover 2. For example, the lift sensor 47 and the contact sensor 48 are each configured to include a board having a Hall sensor.

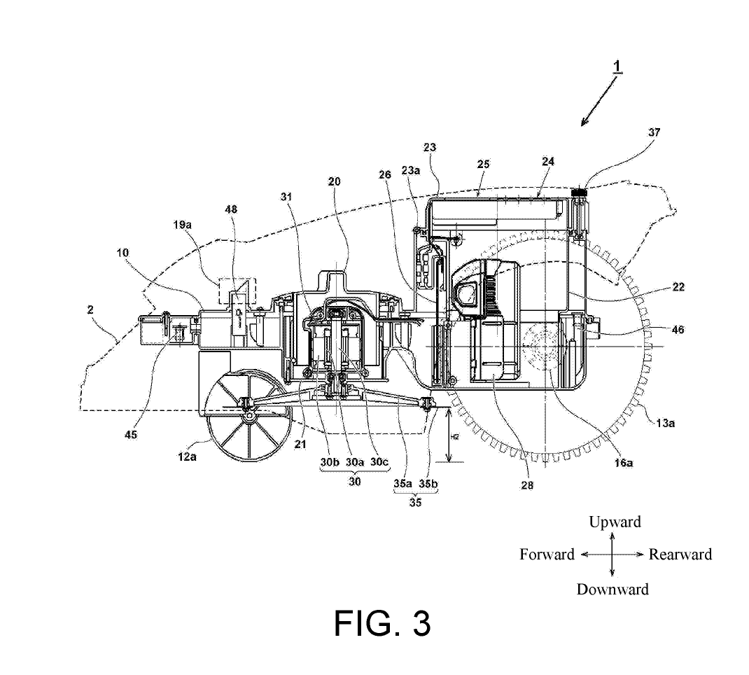

A container portion 22 which accommodates the battery pack (described below with reference to FIG. 3) and accommodates a main board mounted with a microcomputer is provided on the rear side of the main body chassis 10. An opening portion of the container portion 22 is covered with a lid portion 23 which can be opened and closed. The display 25 such as a liquid-crystal display panel, the keyboard 24, and a main switch 42 are provided on the top surface of the lid portion 23. A worker can set a grass-mowing schedule and the like by operating the keyboard 24.

Although the configuration is not illustrated in FIG. 2, a rotary cutting blade 35 (refer to FIG. 3) rotating in a manner of being parallel to the ground with a predetermined distance rotates coaxially with the rotation center of the dial 20. A cutting blade motor 30 (described below with reference to FIG. 3) is provided between the front wheels 12a and 12b and the rear wheels 13a and 13b when seen in a forward/rearward direction of the main body chassis 10. The cutting blade 35 is disposed such that an outer edge position is included within a virtual quadrangular range formed by connecting the center positions of the front wheels 12a and 12b and the rear wheels 13a and 13b. In addition, the outer edge position of the main body cover 2 indicated with the dotted line is set to be positioned sufficiently outside from the outer edge position of the cutting blade 35, so that the clearance between the cutting blade 35 and the main body cover 2 is sufficiently ensured.

FIG. 3 is a sectional view of the A-A part in FIG. 2 seen in the rightward direction (vertically sectional view passing through the laterally central position in the grass mower 1). The main body cover 2 has a shape which covers approximately the entire main body chassis 10 except for the ground side. The main body cover 2 is held in a state of being floated with respect to the main body chassis 10 by a spring or the like, so that the main body cover 2 is slightly movable in the forward, rearward, rightward, leftward, upward, and downward directions. The main body cover 2 sometimes bumps into an obstacle such as a rock, a projection, and a wall. Therefore, when the contact sensor (described below) or the like detects a relative positional fluctuation of the main body cover 2 at that time, the control device (described below) detects a collision or the like of the grass mower 1.

The cutting blade 35 which has the plurality of blades 35b and rotates on a plane substantially parallel to the ground is provided on the lower side near the center of the main body chassis 10. A drive device (cutting blade motor 30) for rotating the cutting blade 35 is accommodated inside a motor housing 21. The motor housing 21 is configured to be movable in the upward/downward direction with respect to the main body chassis 10 when the dial 20 is rotated. The motor housing 21 is lifted and lowered in the upward/downward direction integrally with the drive device when the height of the cutting blade 35 is adjusted. FIG. 3 illustrates a state in which the cutting blade motor 30 and the cutting blade 35 are at the highest positions (cutting blade height H2=60 mm).

The cutting blade motor 30 is accommodated inside the cup-shaped motor housing 21 having an opening on the top. The cutting blade motor 30 is disposed such that a rotary shaft 30c extends in a vertical direction. A lower end of the rotary shaft 30c penetrates a penetration hole formed in the motor housing 21 and extends to the lower side. The cutting blade 35 is attached to the lower end thereof. In the cutting blade 35, the metal blades 35b are provided at several locations on an outer circumferential side of a synthetic resin frame 35a formed in a disk shape. The cutting blade 35 rotates within a horizontal plane at the height H2 which has been set with respect to the ground.

The cutting blade motor 30 is a brushless DC motor, in which a rotor core 30a having a permanent magnet rotates inside a stator core 30b around which an excitation coil is wound. A circular inverter circuit board 31 is provided on one side (here, the upper side) of the stator core 30b. A plurality of Hall ICs (not illustrated) for detecting the position of the rotor core 30a, and a plurality of switching elements such as a field effect transistor (FET) and an insulated-gate bipolar transistor (IGBT) are mounted in the inverter circuit board 31.

A substantially rectangular parallelepiped container portion 22 for accommodating a battery pack 28, the main board 26, and the like is provided on the rear side of the cutting blade motor 30. The container portion 22 is manufactured by performing integral molding of a synthetic resin such as plastic. The container portion 22 has an opening on the upper side and is provided with a hinge 23a for opening and closing the lid portion 23. The opening is closed by the lid portion 23. The battery pack 28 accommodated in the container portion 22 is an attachable/detachable battery pack, and a plurality of rechargeable battery cells (not illustrated) are accommodated therein. A lid operation unit 37 constituted by a screw and the like for fixing opening and closing of the lid portion 23 on a side opposite to the hinge 23a is provided near the rear end on the upper side of the container portion 22.

A first guidewire sensor 45 is provided near the front end of the main body chassis 10, and a second guidewire sensor 46 is provided near the rear end thereof. The guidewire sensors 45 and 46 convert a change in a peripheral magnetic field into a change in a current by means of the coil. Here, the attachment orientation of the guidewire sensors 45 and 46 is set such that an axial direction (direction of detecting a magnetic field) of a coil (not illustrated) becomes the upward/downward direction (vertical direction). The guidewire sensor 46 on the rear side is disposed such that a vertically central position thereof approximately coincides with the heights of the rotary shafts of the motors 16a and 16b for driving the rear wheels. When the position of the guidewire sensor 46 is set in this manner, it is possible to suppress an influence of noise received by the guidewire sensor 46 due to the motors 16a and 16b.

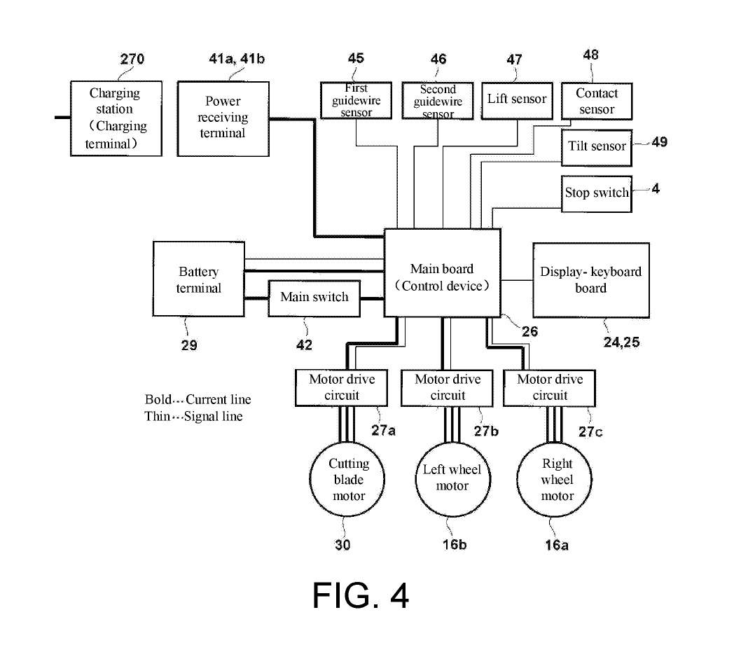

FIG. 4 is a block diagram illustrating various functional components installed in a main body chassis 10 of the grass mower 1. The control device which controls an operation of the grass mower 1, a power source circuit (not illustrated), and the like are mounted in the main board 26. The control device includes a microcomputer (not illustrated) (hereinafter, will be referred to as a “microcomputer”), a storage device, and other electronic elements. The power receiving terminals 41a and 41b which can be connected to two power transmission terminals (positive electrode and negative electrode) of the charging station 270, and a battery terminal 29 which is connected to terminals (outlet voltage terminal and terminal for identification (not illustrated)) of the battery pack 28 mounted in a battery attachment portion, in a freely attachable/detachable manner, are connected to the main board 26. The main switch 42 is inserted into a connection line path between the battery terminal 29 and the main board 26. The main switch 42 is a switch for supplying power to the main board 26, the motor, and the like of the grass mower 1.

The cutting blade motor 30, the right wheel motor 16a, and the left wheel motor 16b are connected to the main board 26. When driving power is supplied from the main board 26 via motor drive circuits 27a to 27c, the cutting blade 35 rotates and the rear wheels 13a and 13b are driven independently. The motor drive circuits 27a to 27c include an inverter circuit. A three-phase AC excitation current is generated from a DC power source in accordance with a PWM control signal controlled by the microcomputer, thereby rotating the cutting blade motor 30, the right wheel motor 16a, and the left wheel motor 16b. When the microcomputer causes the cutting blade motor 30 to rotate, the cutting blade 35, which is directly connected to the rotary shaft 30c of the cutting blade motor 30 without the deceleration mechanism, rotates. In addition, when the microcomputer causes the right wheel motor 16a and the left wheel motor 16b to rotate in an interlocked manner or a non-interlocked manner, the rear wheels 13a and 13b rotate.

The keyboard 24, the display 25, and the stop switch 4 are connected to the main board 26. Moreover, various types of sensors such as the first (front side) guidewire sensor 45, the second (rear side) guidewire sensor 46, the lift sensor 47, the contact sensor 48, and an inclination sensor 49 are connected to the main board 26. A signal detected by the coils of the first and second guidewire sensors 45 and 46 is output to the main board 26, and the boundary of a grass-mowing region is recognized by the microcomputer mounted in the main board 26. The microcomputer performs directional control and the like of the grass mower 1 by independently driving the motor 16b of the left wheel and the motor 16a of the right wheel in accordance with the recognition result, so that the grass mower 1 moves forward, moves rearward, and makes a turn. The lift sensor 47 detects the state when the main body chassis 10 of the grass mower 1 is lifted or when the grass mower 1 inclines with respect to the ground at a predetermined angle or more. In this case, the microcomputer stops the right wheel motor 16a, the left wheel motor 16b, and the cutting blade motor 30. The contact sensor 48 detects an impact when the grass mower 1 comes into contact with something. The inclination sensor 49 detects the state when the grass mower 1 inclines with respect to the ground at a predetermined angle or more, so that the grass mower 1 is prevented from infiltrating into the inclined surface.

The stop switch 4 (refer to FIG. 1) which is manual stopping means for a stop is provided at a position, in which the stop switch 4 can be easily operated, in the upper portion on the rear end side of the main body cover 2. Accordingly, a user can stop the grass mower 1 during automatic traveling or grass-mowing by performing a manual operation. The keyboard 24 and the display 25 mounted in the keyboard 24 are devices for inputting and outputting information related to grass-mowing. The devices are disposed such that an operator can have access thereto when the operator opens the opening/closing cover 3 provided in the main body cover 2. The devices are used for setting an instruction of an operation start, setting a timer, and setting a work region and the like. Although the keyboard 24 is provided in this case, a touch-type liquid crystal display may be used as the display 25 such that the devices are integrally formed.

In the configuration of the grass mower 1 described above, when the battery pack 28 is mounted in the battery attachment portion of the main body chassis 10 and the main body chassis 10 is positioned in the charging station 270, the control device on the charging station 270 side determines the connection of the grass mower 1 and supplies a DC voltage for charging from a power transmission circuit (not illustrated) to the main body chassis 10. A charging circuit charges the battery pack 28 with a rated output voltage. After charging is completed, the microcomputer controls a relay (not illustrated) and switches the battery pack 28 from a load side (side on which power is supplied to the motors and the like) to a side to be connected to the motors 16a, 16b, and 30. Thereafter, the grass mower 1 leaves the charging station 270 and performs a grass-mowing operation according to an automatic traveling program which is set in advance by the microcomputer on the main board 26. The grass mower 1 returns to the charging station 270 when a required grass-mowing operation ends or when the residual quantity of the battery pack 28 drops.

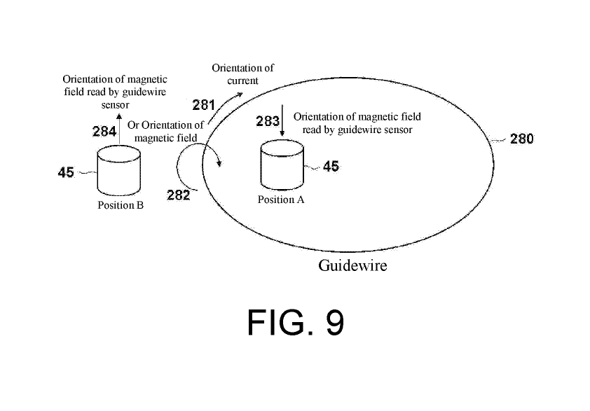

Next, a position detecting method using the guidewire sensor 45 will be described using FIG. 9. In the present Example, a plurality of pulse currents having a width of 5 micro-seconds are flowed in a predetermined pattern on a guidewire 280 wired in a loop at a cycle of 15 milliseconds. When a current is passed in a direction of an arrow 281 on the guidewire 280 disposed on the ground or near the ground as in FIG. 9, a magnetic field 282 is formed as depicted concentric circle around it (right-hand rule). The magnetic field 282 is oriented downward from above with respect to the ground inside a closed space formed by the guidewire 280, as indicated with an arrow 283 and is oriented downward from above with respect to the ground outside the closed space, as indicated with an arrow 284. That is, when the guidewire sensor 45 of the grass mower 1 is within the guidewire 280 as indicated with a position A in the drawing, the magnetic field read by the guidewire sensor 45 is oriented (arrow 283) downward from above. Meanwhile, when the guidewire sensor 45 is out of the guidewire 280 as indicated with a position B in the drawing, the magnetic field read by the guidewire sensor 45 is oriented (arrow 284) upward from below. Utilizing this principle, the grass mower 1 can identify whether the grass mower 1 is within (position A) the region enclosed by the guidewire 280 or out (the position B) of the region, based on the orientation of the magnetic field read by both the guidewire sensors 45 and 46.

In order to detect the position of the guidewire 280 depending on which direction the magnetic field is, it is important to dispose the guidewire sensor such that the axial direction of the coil is set in the perpendicular direction. In the present example, since guidewire sensors are provided near the end portion on the front side in the traveling direction (first guidewire sensor 45) and near the end portion on the rear side (second guidewire sensor 46) and both the guidewire sensors perform detection in the same manner, it is possible to detect even a state in which the grass mower 1 straddles the guidewire 280. Moreover, when the grass mower 1 moves along the guidewire 280 such that a laterally central point of the grass mower 1 is on the guidewire 280, an output of the guidewire sensors 45 and 46 is weakened characteristically. However, detection can be performed even in such a state. When the orientation of a flow of the current 281 is inverted, the orientations (arrows 283 and 284) of the magnetic fields read by the guidewire sensors are also inverted. Therefore, a pulse group (details will be described below), in which the orientation of a current flowing in the guidewire 280 is cyclically changed, is employed so that it is possible to correctly identify whether the grass mower 1 is within or out of the guidewire 280 based on current values detected by the guidewire sensors 45 and 46.

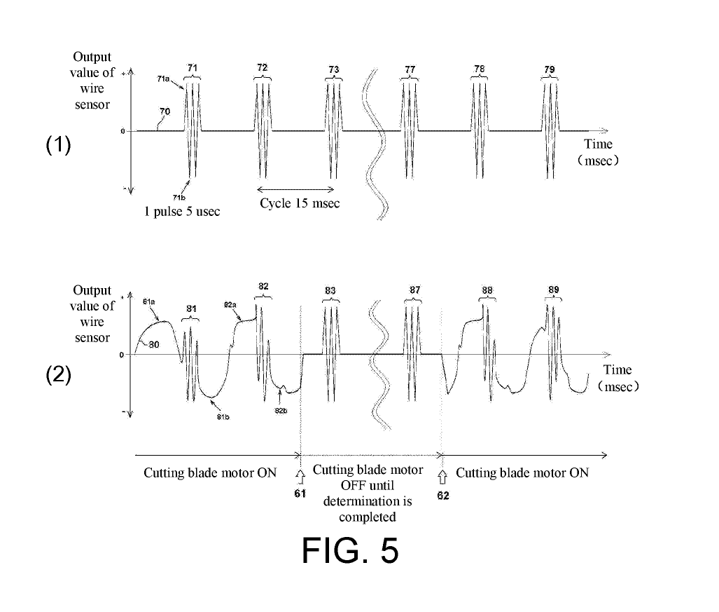

FIG. 5 is a view illustrating a waveform of a signal detected by a guidewire sensor of a grass mower 301. The drawing illustrates a current value detected when the first guidewire sensor 45 is at a position within the guidewire 280 (position A). The guidewire sensor 45 converts a change in a magnetic field at the position into a voltage by means of the coil (the same also applies to the guidewire sensor 46). The microcomputer reads the voltage and compares whether the voltage coincides with a current pattern of the guidewire 280 stored in the microcomputer, thereby determining the signal from the guidewire 280. (1) illustrates an ideally read waveform (current value 70) when there is no influence of noise of the motor or the like. A current (guidewire signal) having a predetermined pattern is passed in the guidewire 280 of the present example. The guidewire sensor 45 detects a positive current when the guidewire sensor 45 is positioned within the guidewire 280, that is, when a current flows in the orientation 281 as in FIG. 9. The guidewire sensor 45 detects a negative current when the orientation of a current flows in a direction opposite to the orientation 281. A guidance signal causes a short current to flow in the direction of the arrow 281 in FIG. 9 (first positive side pulse). Next, a short current is passed in a direction opposite to the arrow 281 (first negative side pulse). Next, a short current is passed in the direction of the arrow 281 (second positive side pulse). Next, a short current is passed in the direction opposite to the arrow 281 (second negative side pulse). Finally, a short current is passed in the direction of the arrow 281 (third positive side pulse). In this manner, a pulse group 71 having three positive side pulses 71a and two negative side pulses 71b is formed. Since the pulse groups 71 to 79 appear in a 15-millisecond cycle, the microcomputer can correctly identify whether the grass mower 1 is within or out of the guidewire 280 by detecting the number of positive side pulses and negative side pulses based on a signal detected by the guidewire sensor 45. When the guidewire sensor 45 is positioned out of the guidewire 280, a waveform having a vertically inverted shape of the waveform in (1) is detected due to the inverted direction of a magnetic field. However, it is possible to correctly identify that the grass mower 1 is out of the guidewire 280 (position B) by identifying the polarity (negative side when being positioned outside) on a side where three pulses have appeared.

FIG. 5(2) illustrates an example of a waveform actually detected by the guidewire sensor 45 during grass-mowing performed by the grass mower 301. In a current value 80, the cutting blade motor 30 driving the cutting blade 35 is being energized up to the point of time of an arrow 61 including pulse groups 81 and 82. In this section, the current value 80 is influenced by a leakage magnetic field from the cutting blade motor 30, so that significant turbulence (noise) of the waveform is detected in the detected current value 80, as indicated with arrows 81a, 81b, 82a, and 82b. An example of noise is illustrated in this case. However, in general, the magnitude or the orientation of noise cannot be estimated since they are not uniform. It is possible to consider to take proactive countermeasures such as eliminating noise based on a current of the cutting blade motor 30. However, although the magnitude or the orientation of noise can be estimated if the load of the cutting blade motor 30 is determined, since the load applied to the cutting blade motor 30 varies every time due to the growing state of the lawn or the density of the lawn in practice, it is difficult to estimate a current of the cutting blade motor 30 and a change in a magnetic field thereof.

As a result of the verification of the inventors, it has been ascertained that the cutting blade motor 30 exerts noise on the guidewire sensor 45 because a leakage magnetic flux appears when a current flows in the stator of the cutting blade motor 30 and the orientation of the magnetic flux is close to the orientation of the coil of the guidewire sensor 45. Particularly, the rotary shaft 30c of the cutting blade motor 30 is set in the vertical direction, and the direction of a leakage magnetic flux becomes the vertical direction. Meanwhile, in motors of which the rotary shaft is set in the horizontal direction (right wheel motor 16a and left wheel motor 16b), a leakage magnetic flux is often in the transverse direction. Therefore, it is ascertained that the influence is reduced when the center position in the height direction with respect to the guidewire sensors 45 and 46 is set to be the same. An influence of noise from the vertically placed cutting blade motor 30 can be eliminated by removing the magnetic field leaking from the cutting blade motor 30. In this case, whether the cutting blade motor 30 is rotating or is stopped is not a significant problem, but the presence or absence of a leakage magnetic field is a problem. This is because the noise influencing the current value 80 becomes a problem not due to noise which has picked up an electromagnetic wave but due to noise accompanied by a fluctuation of a magnetic flux, that is, a leakage magnetic flux from the stator core and the coil of the cutting blade motor 30. Therefore, the present example is configured to temporarily stop supplying power source to (energizing) the cutting blade motor 30 and to achieve a state having no influence of noise when the guidewire sensors 45 and 46 detect a guidance signal from the guidewire 280, thereby detecting a guidance signal while the cutting blade motor 30 is stopped. The section of pulse groups 83 to 87 in (2) illustrates a waveform detected by the guidewire sensor 45 while the cutting blade motor 30 stops being energized.

The supply of electricity to the cutting blade motor 30 is stopped at predetermined time intervals during grass-mowing work of the grass mower 1. When a current is caused to flow in the cutting blade motor 30 for 500 milliseconds, energization to the cutting blade motor 30 is completely stopped. This stop is effective when conduction of the switching elements included in a motor drive circuit 27a (refer to FIG. 4) is in a cut-off state. The guidewire sensors 45 and 46 detect a guidance signal while the cutting blade motor 30 stops being energized. In this detection, a plurality of signals in the pulse groups 83 to 87 are continuously and correctly detected as guidance signals. A plurality of signals are continuously detected in order to prevent an erroneous operation and to enhance reliability. When the detection of guidance signals performed by the guidewire sensors 45 and 46 is completed, a drive current restarts to be supplied to the cutting blade motor 30 at timing indicated with the arrow 62. Therefore, the time to stop the cutting blade motor 30 is not uniform, and there are cases in which the time varies every time detection is performed.

When the cutting blade motor 30 temporarily stops being energized, the cutting blade 35 continues to rotate due to momentum of inertial force and the rotational speed of the cutting blade 35 pulsates slightly. However, the state of continuously rotating remains unchanged. Therefore, there is little possibility of being anxious about deterioration of the efficiency of grass-mowing work. In addition, the wheel motors 16a and 16b may remain being driven without stopping. Therefore, traveling control of the grass mower 1 is not influenced at all. At the arrow 62 in FIG. 5(2), when the cutting blade motor 30 restarts to be energized after the pulse group 87, the cutting blade motor 30 is in processing similar to that described above, that is, a repetitive course of energization, inertial rotation, energization, inertial rotation, and so on.

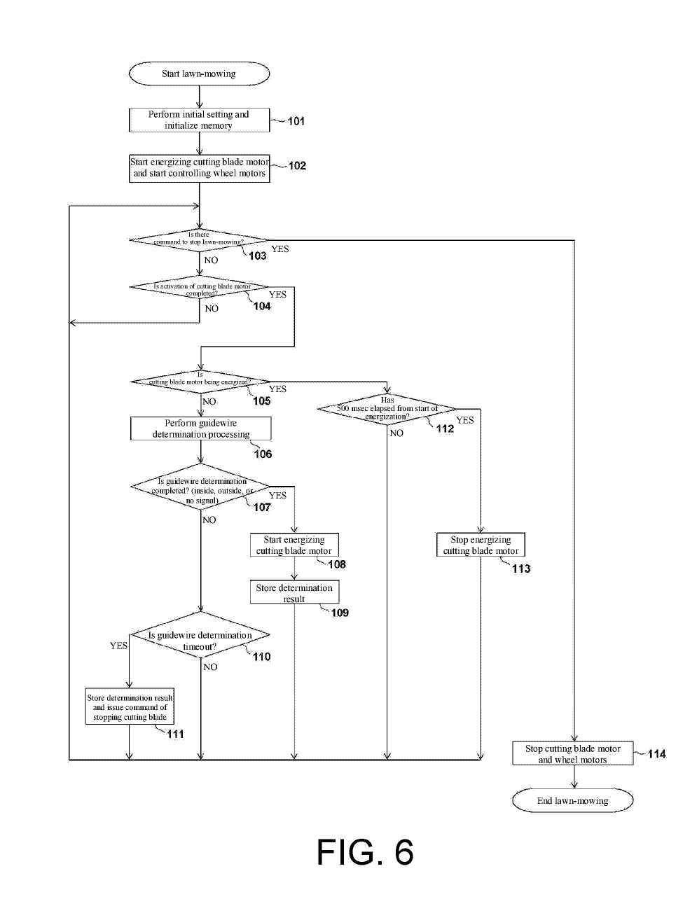

FIG. 6 is a flowchart illustrating a procedure in which the guidewire reads a guidance signal in the grass mower 1 according to the present Example. The series of procedures illustrated in FIG. 6 can be executed in a manner of software through a program stored in advance in the control device having the microcomputer. When a lawn-mowing operation starts, first, the microcomputer performs initial setting of a counter and initializes a temporary storage memory required in control (Step 101). Here, a timer for counting a running time of the cutting blade motor 30, a memory for storing determination results of the guidewire sensors 45 and 46, a stop command memory for storing the presence and absence of a command to stop grass-mowing, and the like are initialized. Next, the microcomputer starts energizing the cutting blade motor 30, and the cutting blade 35 rotates (Step 102). Since the cutting blade motor 30 is a brushless DC motor, a gate signal is supplied to a plurality of field effect transistors (FETs) included in the inverter circuit, so that a predetermined drive current is supplied to the coil of the cutting blade motor 30. In addition, the microcomputer starts energizing the wheel motors (right wheel motor 16a and left wheel motor 16b), and the grass mower 1 starts traveling (Step 102).

Next, the microcomputer determines whether or not there is a command to stop the grass-mowing operation based on the content of the stop command memory (Step 103). A stop command includes various factors such as a case in which a predetermined grass-mowing operation ends, a case in which an occurrence of some abnormality is detected, and a case in which the stop switch 4 for a stop is operated, for example. The state of a stop command in this case can be checked through the content of the stop command memory. When there is a command to stop grass-mowing in Step 103, the cutting blade motor 30 and the wheel motors (right wheel motor 16a and left wheel motor 16b) stop being energized, so that the operation of the grass mower 1 stops (Step 114) and the grass-mowing operation stops.

When there is no command to stop grass-mowing in Step 103, it is determined whether or not activation of the cutting blade motor 30 is completed. When the activation is not completed or when the cutting blade motor 30 is stopped, the procedure returns to Step 103 (Step 104). When the activation of the cutting blade motor is completed in Step 104, it is determined, in Step 105, whether or not the cutting blade motor 30 is continuously energized. When the cutting blade motor 30 is being energized, the procedure shifts to Step 112. In Step 112, it is determined whether or not a predetermined time period, 500 milliseconds in this case, has elapsed from when the cutting blade motor starts to be energized. When the predetermined time period has elapsed, the cutting blade motor 30 stops being energized (Step 113), and the procedure returns to Step 103. The cutting blade motor 30 stops only being energized, and no brake control is performed by means of a short circuit or the like between the coils. Therefore, the cutting blade motor 30 continues to rotate due to inertia. When 500 milliseconds have not elapsed in Step 112, the procedure returns to Step 103.

In Step 105, when the cutting blade motor 30 is not being energized, that is, when the cutting blade motor 30 stops being energized, the microcomputer detects a guidance signal generated from the guidewire 280, based on an output signal of the guidewire sensors 45 and 46, thereby performing determination processing whether or not the grass mower 1 is in a grass-mowing region 290 (Step 106). In this determination, a side where three pulses appear in a plurality of pulse waveforms appearing on the positive and negative sides is detected. For example, in the pulse group 83 in FIG. 5(2), three pulses appear on the positive side, and two pulses appear on the negative side. Accordingly, the microcomputer can determine that the grass mower 1 is within the grass-mowing region 290. Incidentally, when the grass mower 1 is out of the grass-mowing region 290, in regard to the pulse group, three pulses appear on the negative side, and two pulses appear on the positive side. In this manner, when determination of “inside” is obtained as many as the number of continuous groups in the pulse group which appear in a 15-millisecond cycle, the microcomputer makes final determination of “within the grass-mowing region 290”. On the contrary, when determination of “outside” is obtained as many as the number of continuous groups in the pulse group, the microcomputer makes final determination of “out of the grass-mowing region 290”.

In this manner, at the point of time when detection of the region is completed and the result is obtained correctly, Step 107 proceeds to YES, and the microcomputer restarts to energize the cutting blade motor 30 (Step 108). Next, the determined result is stored in the memory. The determination result stored in the memory is used for controlling in a traveling control program (processed together with the flowchart in FIG. 4 and is not illustrated herein) for performing control over the wheel motors. In the traveling control program (not illustrated), the wheel motors (right wheel motor 16a and left wheel motor 16b) are controlled in accordance with the obtained position determination result and a route control program. When necessary, a steering instruction is performed. For example, when the guidewire sensor 45 determines the outside, and the guidewire sensor 46 determines the inside, only one of the wheel motors may be caused to stop so that the grass mower 1 is inverted 180 degrees (makes a U-turn). In addition, when both the guidewire sensors 45 and 46 determine the outside, the grass mower 1 may be caused to move rearward, or the grass mower 1 may be stopped.

When the determination is not completed in Step 107 (in a case of NO), it is determined whether or not the final determination using the guidewire sensors 45 and 46 has ended before the timeout time, that is, whether or not it is a timeout (Step 110). When determination cannot be made within a predetermined time period (timeout time), the determination result is stored in the memory, and the cutting blade motor continues to stop being energized (Step 111). In this case, it is favorable that the display 25 displays an error code. The cutting blade motor 30 also performs brake control at the same time as the energization is stopped. In addition, since the wheel motors are driven via speed reducers, the wheel motors have a configuration in which momentum traveling is suppressed due to resistance, but the brake control may be performed at the same time. When determination can be made within a predetermined time in Step 110, the procedure returns to Step 103. The flowchart in FIG. 6 illustrates only the procedure of reading a guidance signal from the guidewire. According to the description, the traveling control program is executed together with the procedure in FIG. 6. However, in addition thereto, the microcomputer also performs control such as management of the residual quantity of the battery pack 28, management of schedules, and display control.

According to the present example, the cutting blade motor 30 can be intermittently driven such that energization stops at uniform intervals, and noise with respect to the guidewire sensors 45 and 46 can be removed while the cutting blade motor stops being energized, by instantaneously stopping driving the cutting blade motor. In the present example, since the guidewire sensors 45 and 46 detect a guidance signal mainly in a state in which this noise is removed, a guidance signal can be read correctly. In addition, since the cutting blade motor 30 and the guidewire sensor 45 can approach each other due to the intermittent driving of the cutting blade motor 30, the main body chassis 10 can be reduced in size. Moreover, since there is no need to concern about an influence of noise from the cutting blade motor 30 with respect to the guidewire sensors 45 and 46, a large current can flow through the cutting blade motor 30. Thus, it is possible to carry out more powerful mowing work.

### Example 2

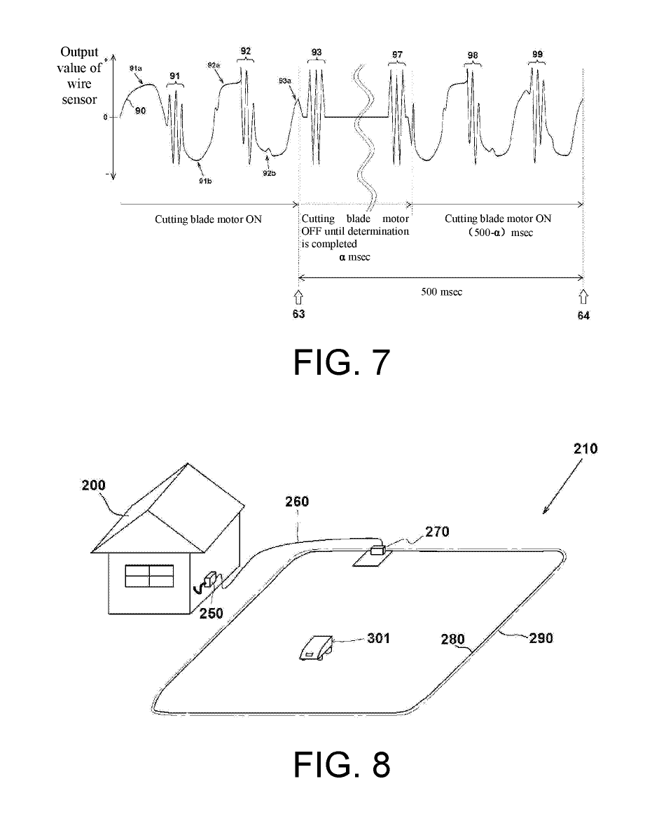

Next, a second example of the present invention will be described using FIG. 7. The second example is different from the first example only in setting a continuous time period for motor-ON, and the basic control method is the same as that of the first example. Here, the length of a period for energizing the cutting blade motor 30 is adjusted such that the interval of timing for stopping the cutting blade motor 30 (stop starting timing, the arrows 63 and 64) becomes uniform. For example, the cutting blade motor 30 is turned off, and an influence of noise such as arrows 91a, 91b, 92a, and 92b with respect to a current value 90 is removed. Then, detection of a guidance signal starts at the point of time of the arrow 63. When a guidance signal is detected by means of the plurality of pulse groups 93 to 97, if it takes a milliseconds as the detection time period, the successive ON time period for the cutting blade motor 30 is set to 500-α milliseconds. Then, the cutting blade motor 30 stops being energized again at the timing of the arrow 64 when 500 milliseconds have elapsed from the arrow 62, and the guidewire sensors 45 and 46 detect a guidance signal. Similar control is repetitively performed hereinafter. In this manner, since the interval of the time to start stopping the cutting blade motor 30 becomes uniform, the time interval of the time to start stopping the cutting blade motor 30 becomes uniform, and thus the working sound becomes uniform.

Hereinabove, the present invention has been described based on the examples. However, the present invention is not limited to the examples described above, and various changes can be made within the scope not departing from the gist thereof. For example, a guidance signal flowing in the guidewire is not limited to the pattern in the examples described above, and a different pattern may be employed. In addition, if a voltage supplied to the cutting blade motor 30 can be changed (however, except for a method of lowering an effective value voltage by repeating ON-OFF of a current through chopper control), noise at the time of detecting a signal using a guidewire sensor may be greatly reduced by drastically lowering the voltage instead of stopping energization when the guidewire sensors 45 and 46 detect a guidance signal.

### REFERENCE SIGNS LIST

1 Grass mower; 2 Main body cover; 2a, 2b Fender; 2c Front lower end of main body cover; 3 Opening/closing cover; 4 Stop switch; 5 Opening portion; 10 Main body chassis; 11a, 11b Attachment arm; 12a, 12b Front wheel; 13a, 13b Rear wheel; 14 Base portion; 16a Right wheel motor; 16b Left wheel motor; 17a, 17b, 18a Recess portion; 19a, 19b Magnet; 20 Dial; 21 Motor housing; 22 Container portion; 23 Lid portion; 23a Hinge; 24 Keyboard; 25 Display; 26 Main board; 27a to 27c Motor drive circuit; 28 Battery pack; 29 Battery terminal; 30 Motor (cutting blade motor); 30a Rotor core; 30b Stator core; 30c Rotary shaft; 31 Inverter circuit board; 35 Cutting blade; 35a Frame; 35b Blade; 37 Operation unit; 41, 41a, 41b Power receiving terminal; 42 Main switch; 45, 46 Guidewire sensor; 47 Lift sensor; 48 Contact sensor; 49 Tilt sensor; 70 Current value; 71 to 79 Pulse group; 71a Positive side pulse; 71b Negative side pulse; 80 Current value; 81 to 89 Pulse group; 90 Current value; 91 to 99 Pulse group; 200 House; 210 Yard; 250 AC adapter; 260 Cable; 270 Charging station; 280 Guidewire; 282 to 284 Orientation of magnetic field; 290 Grass-mowing region; and 301 Grass mower.

1. A self-propelled grass mower comprising:
a wheel motor, driving a wheel;
a cutting blade motor, driving a cutting blade;
a rechargeable battery, supplying power to the wheel motor and the cutting blade motor;
a guidewire sensor, detecting a magnetic field generated by a current flowing in a guidewire which is formed in a loop shape; and
a control device, determining, based on an output of the guidewire sensor, whether the self-propelled grass mower is within or out of a region enclosed by the guidewire, and controlling autonomous traveling in a grass-mowing region,
wherein the control device reduces a voltage supplied to the cutting blade motor when using the guidewire sensor to detect the magnetic field, and increases the voltage supplied to the cutting blade motor after detection of the magnetic field is completed.

2. The self-propelled grass mower according to claim 1,
wherein a voltage supplied to the cutting blade motor is reduced by stopping energization.

3. The self-propelled grass mower according to claim 2,
wherein the cutting blade motor stops being energized at predetermined time intervals during grass-mowing work carried out by the self-propelled grass mower.

4. The self-propelled grass mower according to claim 2,
wherein the cutting blade is a rotary cutting blade which rotates on a plane substantially parallel to a ground,
wherein the cutting blade motor is disposed such that a rotary shaft extends in a vertical direction,
wherein the guidewire sensor has a coil for detecting a change in a magnetic field, and
wherein the coil is disposed such that an axial direction is parallel to the rotary shaft of the cutting blade motor.

5. The self-propelled grass mower according to claim 3,
wherein a guidance signal generator for causing a pulsed current group to flow at predetermined time intervals is connected to the guidewire, and
wherein the control device determines whether the self-propelled grass mower is within or out of the region enclosed by the guidewire, by detecting the change in the magnetic field caused by the current group a plurality of times while the cutting blade motor is stopped, and the control device stops rotation of the wheel motor and rotation of the cutting blade motor when the change in the magnetic field cannot be detected within a timeout period.

6. The self-propelled grass mower according to claim 5,
wherein the control device sets a time for driving the cutting blade motor to be constant and sets a time for stopping energization of the cutting blade motor to be variable.

7. The self-propelled grass mower according to claim 6,
wherein the cutting blade motor is a brushless DC motor and is provided with an inverter circuit having a plurality of switching elements for driving the brushless DC motor, and
wherein the control device stops the energization by causing a PWM duty ratio in conduction of the switching elements to be 0%.

8. The self-propelled grass mower according to claim 1, further comprising:
a main body chassis, holding the wheel motor and the cutting blade motor; and
a main body cover, covering the main body chassis,
wherein a plurality of front wheels are provided on a front side of the main body chassis, a plurality of rear wheels are provided on a rear side, and the wheel motor are respectively provided in the rear wheels, and
wherein the cutting blade motor is provided between the front wheels and the rear wheels when seen in a forward/rearward direction of the main body chassis.

9. A self-propelled grass mower comprising:
a wheel motor , driving a wheel;
a cutting blade motor, driving a cutting blade;
a rechargeable battery, supplying power to the wheel motor and the cutting blade motor;
a guidewire sensor, detecting a magnetic field generated by a current flowing in a guidewire which is formed in a loop shape; and
a control device; determining, based on an output of the guidewire sensor, whether the self-propelled grass mower is within or out of a region enclosed by the guidewire, and controlling autonomous traveling and grass-mowing work,
wherein the control device causes the cutting blade motor to be in a repetitive course of energization, inertial rotation, energization, and inertial rotation when the wheel motor rotates to carry out a grass-mowing work.

10. The self-propelled grass mower according to claim 9,
wherein the control device causes the guidewire sensor to detect the magnetic field when the cutting blade motor rotates by inertia.

11. The self-propelled grass mower according to claim 10,
wherein the control device stops the wheel motor and continues to stop energizing the cutting blade motor, when the detection of the magnetic field by the guidewire sensor cannot be performed for a predetermined time period.

12. A self-propelled wheeled apparatus comprising:
a wheel motor, driving a wheel;
a work tool motor, driving a work tool;
a rechargeable battery, supplying power to the wheel motor and the work tool motor;
a sensing device, detecting a signal generated by a signal output device; and
a control device controlling autonomous traveling in a working region based on an output of the sensing device,
wherein the control device reduces a voltage supplied to the work tool motor when using the sensing device to detect the signal, and increases the voltage supplied to the work tool motor after detection of the signal is completed.

13. A self-propelled wheeled apparatus comprising:
a wheel motor, driving a wheel;
a work tool motor, driving a work tool;
a rechargeable battery, supplying power to the wheel motor and the work tool motor;
a sensing device, detecting a signal generated by a signal output device; and
a control device controlling autonomous traveling in a working region based on an output of the sensing device,
wherein the control device causes the work tool motor to be in a repetitive course of energization, inertial rotation, energization, and inertial rotation when the wheel motor rotates to carry out a grass-mowing work.
